(19) United States
(12) Patent Application Publication
(10) Pub. No.: US 2018/0325022 A1
(43) Pub. Date: Nov. 15, 2018

(54) Systems, Devices, and/or Methods for Managing Debris

(71) Applicant: Michael Kelley, Gretna, VA (US)

(72) Inventor: Michael Kelley, Gretna, VA (US)

(21) Appl. No.: 15/975,639

(22) Filed: May 9, 2018

Related U.S. Application Data
(60) Provisional application No. 62/503,874, filed on May 9, 2017.

(51) Int. Cl. A01D 7/10

(52) U.S. Cl. CPC A01D 7/10

(57) ABSTRACT

Certain exemplary embodiments can provide a system comprising a rake a scraper, and an actuator. The rake is coupleable to a tractor. The rake comprises a plurality of tines. The scraper comprises a metal edge. The actuator is coupleable to the scraper. When the actuator is coupled to the scraper and extended and retracted, the metal edge of the scraper is oriented to pass in proximity to a surface of the plurality of tines, thereby removing debris stuck in the tines.

### CROSS-REFERENCES TO RELATED APPLICATIONS

This application claims priority to, and incorporates by reference herein in its entirety, pending U.S. Provisional Patent Application Ser. No. 62/503874 (Attorney Docket No. 1192-01), filed May 9, 2017.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary embodiment of a system 1000;

FIG. 2 is a perspective view of an exemplary embodiment of a system 2000;

FIG. 3 is a perspective view of an exemplary embodiment of a system 3000;

FIG. 4 is a perspective view of an exemplary embodiment of a system 4000;

FIG. 5 is a perspective view of an exemplary embodiment of a system 5000;

FIG. 6 is a side view of an exemplary embodiment of a system 6000;

FIG. 7 is a side view of an exemplary embodiment of a system 7000;

FIG. 8 is a perspective view of an exemplary embodiment of a system 8000; and

FIG. 9 is a flowchart of an exemplary embodiment of a method 9000.

### DETAILED DESCRIPTION

Certain exemplary embodiments can provide a system comprising a rake a scraper, and an actuator. The rake is coupleable to a tractor. The rake comprises a plurality of tines. The scraper comprises a metal edge. The actuator is coupleable to the scraper. When the actuator is coupled to the scraper and extended and retracted, the metal edge of the scraper is oriented to pass in proximity to a surface of the plurality of tines, thereby removing debris stuck in the tines.

Tractor rakes are used to clean brush, limbs, sticks, and/or plant residues from the earth's surface. Often those cleaning storm debris, farmers, landscapers, vineyard operators, lawn maintainers, and/or ranchers desire to clean such debris prior to plowing and/or planting under the earth's surface. As rakes traverse the earth's surface, debris often accumulates on tractor rakes, which then limits an ability of those rakes to effectively continue to clean. Manual removal of debris can be arduous and/or time consuming for someone attempting to clean using the tractor rakes. Vineyard applications can be particularly challenging as vine debris can adhere to rakes. Such debris needs to be removed from the rakes in order to continue use of the rakes for removal of additional debris.

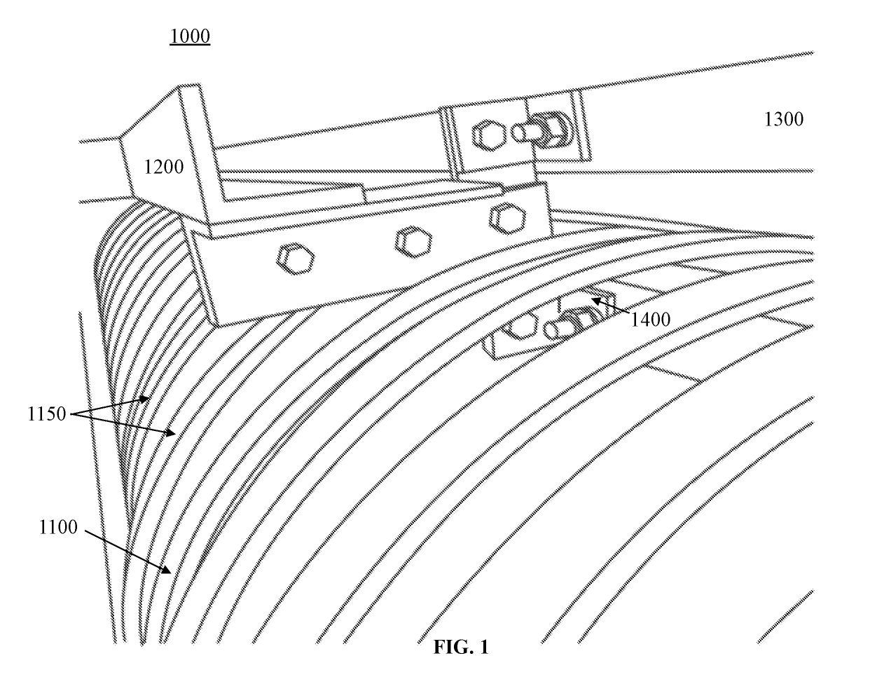

FIG. 1 is a perspective view of an exemplary embodiment of a system 1000, which comprises a rake 1100 coupleable to a tractor. Rake 1100 is coupled to a scraper 1200. Scraper 1200 is constructed to traverse across rake 1100 to clean accumulated debris therefrom. When rake 1100 has accumulated debris between a plurality of tines 1150, scraper 1200 can be actuated, such as by a user, to cause scraper 1200 to traverse a one or more surfaces of rake 1100. Thereby debris can be removed from rake 1100. Scraper 1200 comprises a posterior scraper 1400 and an anterior scraper 1300 each of which facilitates debris removal from rake 1100.

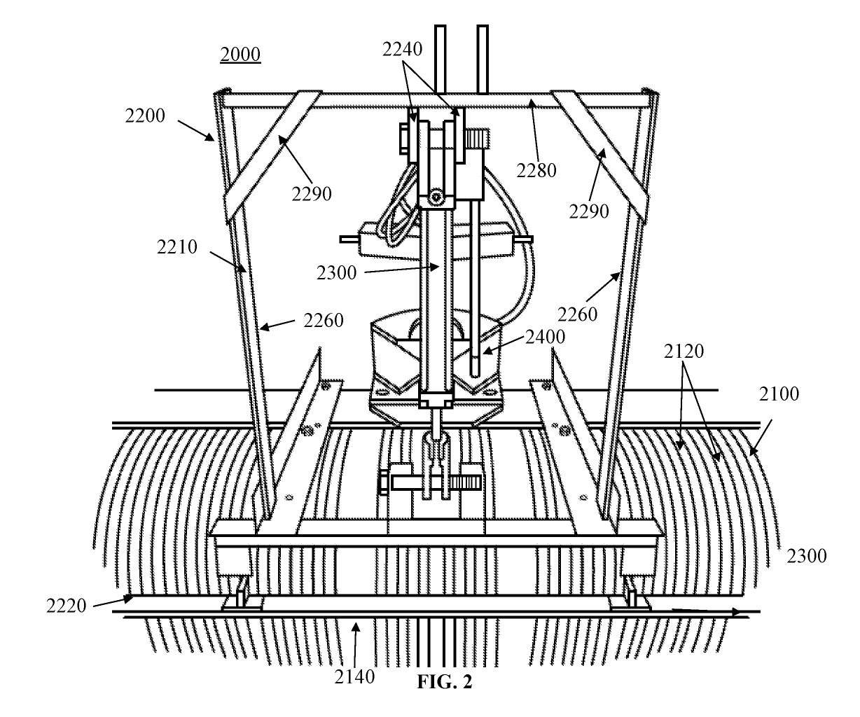

FIG. 2 is a perspective view of an exemplary embodiment of a system 2000, which comprises a rake 2100 and a scraper 2200. Scraper 2200 is constructed to cause a metal edge 2220 to traverse across rake 2100 to clean accumulated debris therefrom. System 2000 comprises an actuator 2300 (e.g., a hydraulic or pneumatic cylinder), which causes scraper 2200 to move downward across rake 2100 and thereby remove any accumulated debris from rake 2100.

Rake 2100 is coupleable to a tractor or other type of machinery. For example, rake 2100 can be coupled to a riding lawnmower, a pickup truck, a skid steer loader, a backhoe, a bulldozer, and/or any other machine capable of motion over a surface to be raked. Rake 2100 comprises a plurality of tines 2120. Scraper 2200 is coupleable to the tractor and/or rake 2100. In certain exemplary embodiments, scraper 2200 is releasably coupleable to the tractor and/or rake 2100. Scraper 2200 comprising metal edge 2220. In certain exemplary embodiments, metal edge 2220 can be comprised by angle iron.

System 2000 comprises a hitch 2400, which is constructed to couple rake 2100 and/or system 1000 to the tractor. Hitch 2400 can define a plurality of hitch apertures, which allow system 2000 to be coupled to the tractor at different angles. Via hitch 2400, system 2000 can cause system 2000 to pivot relative to a direction of travel of the tractor. Thereby, an angle of rake 2100 is adjustable relative to a direction of travel of the tractor.

Actuator 2300 is coupleable to scraper 2200 via a pair of flanges 2240. When actuator 2300 is coupled to scraper 2200 and extended and retracted, metal edge 2220 of scraper 2200 is oriented to pass in proximity to a surface 2140 of plurality of tines 2120, thereby removing debris stuck in plurality of tines 2120.

Scraper 2200 comprises an actuator mounting frame 2210. Actuator mounting frame 2210 comprises pair of flanges 2240. Actuator 2300 is directly coupleable to pair of flanges 2240. Actuator mounting frame 2210 comprising a pair of legs 2260 and a cross member 2280. Cross member 2280 is coupled to pair of flanges 2240. Actuator 2300 is directly coupleable to pair of flanges 2240. A pair of gussets 2290 reinforces pair of legs 2260 and cross member 2280.

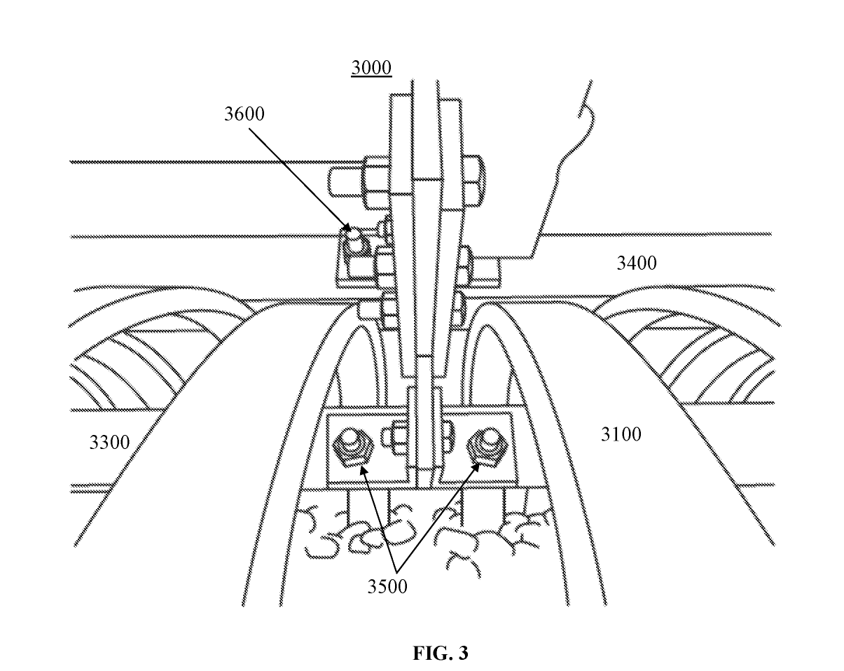

FIG. 3 is a perspective view of an exemplary embodiment of a system 3000, which comprises a rake 3100, a posterior scraper 3300 and an anterior scraper 3400. A plurality of fasteners 3500 can be used to couple posterior scraper 3300 to system 3000. In certain exemplary embodiments, weldments can be used instead of, or in addition to plurality of fasteners 3500. One or more anterior fasteners 3600 can be used to couple anterior scraper 3400 to system 3000. In certain exemplary embodiments, weldments can be used instead of, or in addition to one or more anterior fasteners 3600.

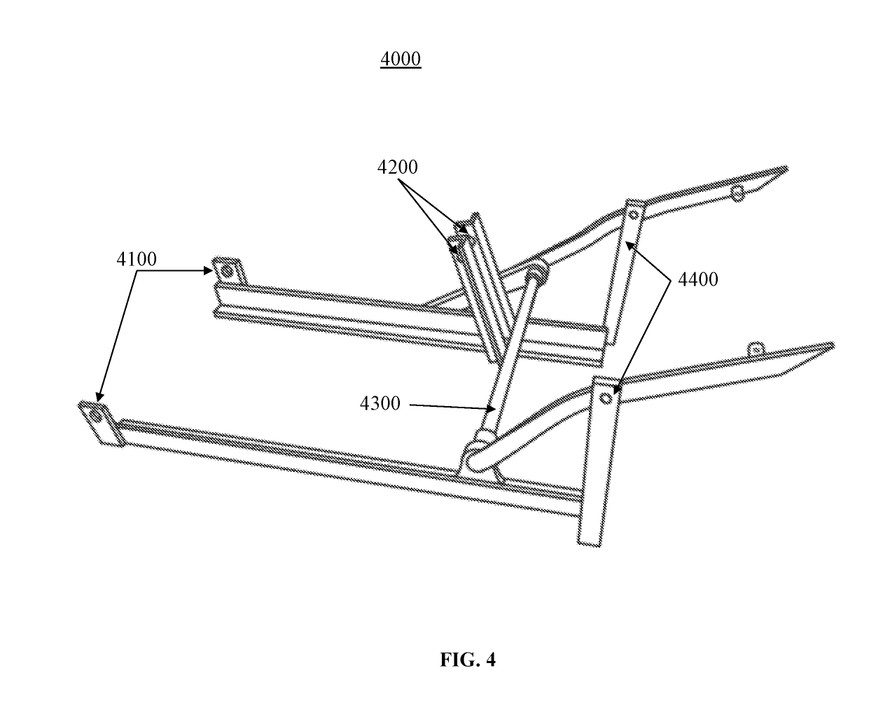

FIG. 4 is a perspective view of an exemplary embodiment of a system 4000, which can be coupled to a piece of mobile equipment via a pair of flanges 4100. System 4000 comprises a pair of flanges 4200 to which an actuator can be coupled. The actuator can be coupled to a scraper that can be utilized to clean debris from tines of a rake. Pair of flanges 4200 are coupled to a shaft 4300, which can rotate. When the actuator is coupled to pair of flanges 4200, shaft 4300 can be rotated to position a scraper (not illustrated in FIG. 4) to a position in proximity to a rake (also not illustrated in FIG. 4). System 4000 can be used as an alternative to scraper 1200 of FIG. 1. A pair of guide legs 4400 can be utilized to act as a guide and restrain motion of scraper edges relative to a rake coupled to the mobile equipment.

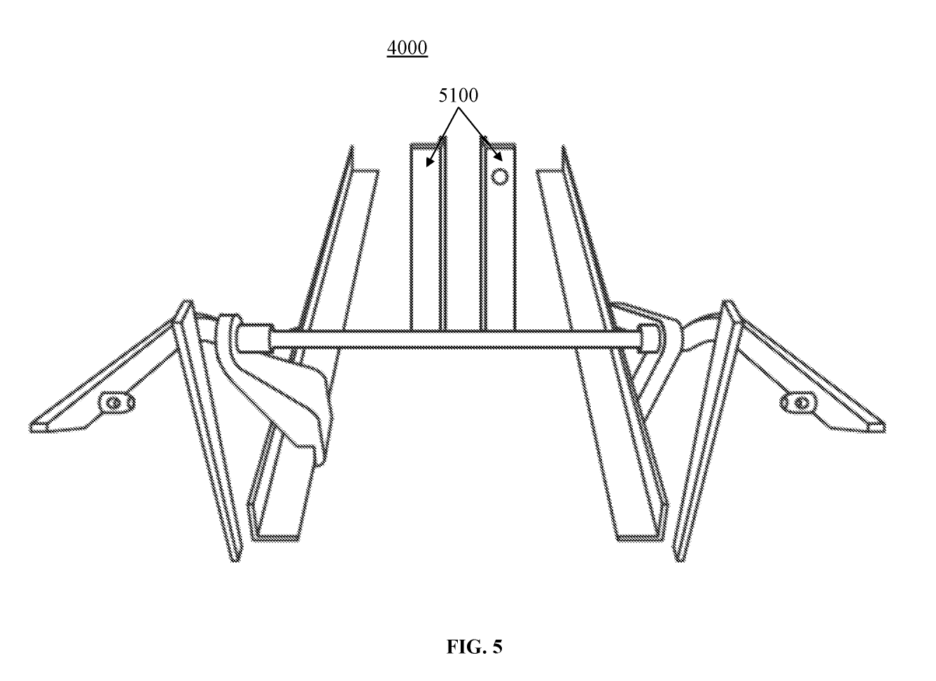

FIG. 5 is a perspective view of an exemplary embodiment of system 4000 from a different angle as compared to FIG. 4.

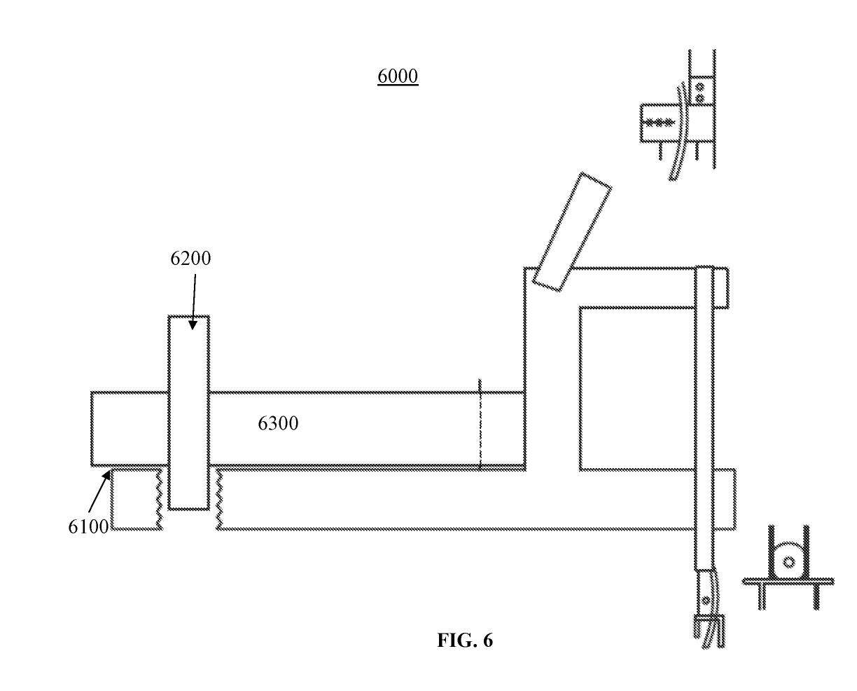

FIG. 6 is a side view of an exemplary embodiment of a system 6000, which illustrates certain fabrication details. System 6000 comprises a rake 6300. System 6000 comprises a metal edge 6100, which in certain exemplary embodiments can be a metal edge of angle iron (e.g., a nominal 3 inch angle iron). System 6000 illustrates an actuator 6200 with a cylinder in an extended position.

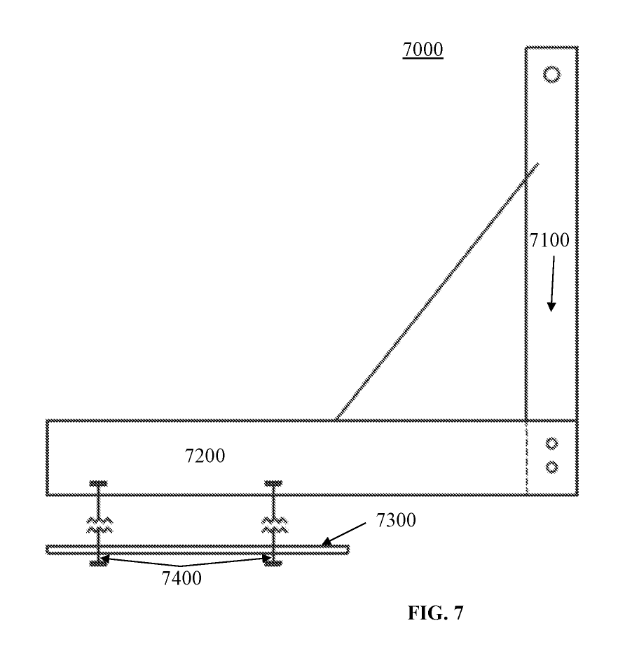

FIG. 7 is a side view of an exemplary embodiment of a system 7000, which illustrates certain dimensions and fabrication details. System 7000 utilizes a gusset 7100. A leg 7200 can be angle iron (e.g., a nominal 3 inch angle iron). A plate 7300 can be coupled to leg 7200 via a plurality of fasteners 7400.

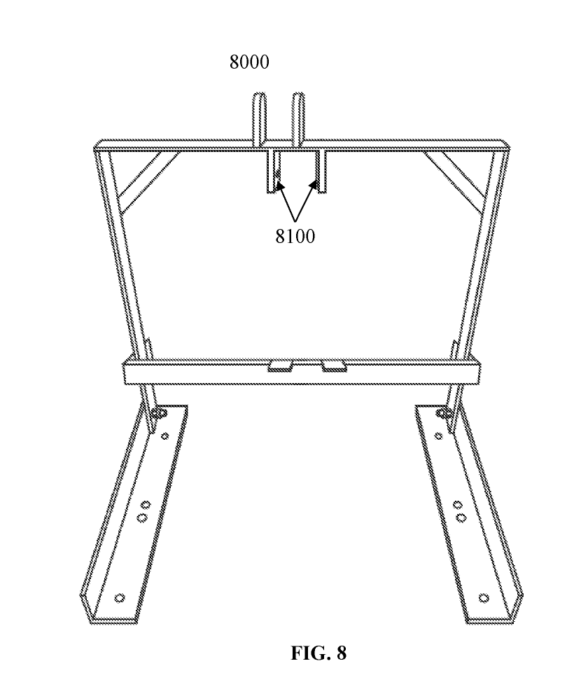

FIG. 8 is a perspective view of an exemplary embodiment of a system 8000, which comprises a pair of flanges 8100 to which an actuator can be coupled. The actuator can be coupled to a scraper that can be utilized to clean debris from tines of a rake.

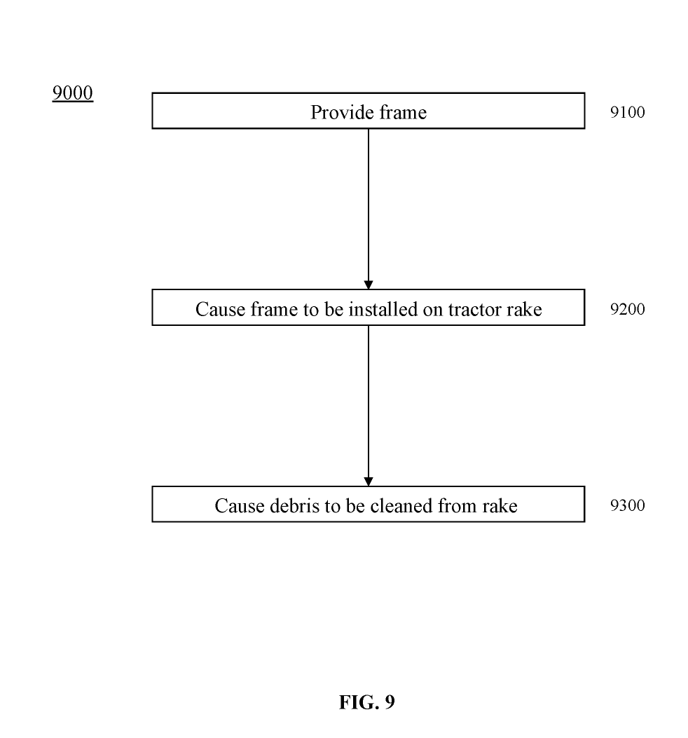

FIG. 9 is a flowchart of an exemplary embodiment of a method 9000. At activity 9100, certain exemplary embodiments comprise providing a frame coupleable to a tractor rake system. At activity 9200, certain exemplary embodiments comprise causing the frame to be installed on the tractor rake system. At activity 9300, certain exemplary embodiments comprise causing debris to be cleaned from the tractor rake system via the frame. For example, an actuated cylinder (e.g., a hydraulic cylinder) can be coupled to the frame and cause the frame to move up and down over a debris capturing portion of the tractor rake system. The frame scrapes the debris off of the tractor rake system onto a debris collection surface.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
actuator—a mechanical device that uses energy to produce a force in a reciprocating linear motion.
adapter—a device used to effect operative compatibility between different parts of one or more pieces of an apparatus or system.
and/or—either in conjunction with or in alternative to.
angle iron—a metal bar with an L-shaped cross section.
aperture—an opening in something.
apparatus—an appliance or device for a particular purpose
associate—to join, connect together, and/or relate.
can—is capable of, in at least some embodiments.
comprising—including but not limited to.
configure—to make suitable or fit for a specific use or situation.
connect—to join or fasten together.
constructed to—made to and/or designed to.
convert—to transform, adapt, and/or change.
couple—to link in some fashion.
coupleable—capable of being joined, connected, and/or linked together.
cross member—a structural component, usually of steel, that is coupled to each of a pair of opposing legs of a frame and from which something supported by the frame can be coupled.
debris—things, such as broken pieces, that are in a location that they are not wanted.
define—to establish the outline, form, or structure of
determine—to obtain, calculate, decide, deduce, and/or ascertain.
device—a machine, manufacture, and/or collection thereof.
directly—substantially without an intervening component or intervening space.
edge—a border at which a surface of an object terminates.
extend—to stretch out in length relative to a retracted position.
flange—a projecting rim of an object that defines an aperture to which something can be releasably coupled.
gusset—a structural component, usually of steel, that is coupled to other frame components to provide structural reinforcement.
hitch—a device constructed to couple a rake system to a tractor.
install—to connect or set in position and prepare for use.
leg—a pole serving as a support.
may—is allowed and/or permitted to, in at least some embodiments.
metal—a material (an element, compound, or alloy) that is typically hard when in solid state, opaque, shiny, and has good electrical and thermal conductivity.
method—a process, procedure, and/or collection of related activities for accomplishing something.
mounting frame—a structure that constructed for the non-destructively removable attachment of a device.
orient—to set or arrange in a determined position.
pass—to move in a path.
plurality—the state of being plural and/or more than one.
predetermined—established in advance.
provide—to furnish, supply, give, and/or make available.
proximity—a state of being near.
rake—an implement equipped with projecting tines that is constructed for moving and/or gathering material such as rocks, plant stalks, plant branches, and plant leaves.
receive—to get as a signal, take, acquire, and/or obtain.
reinforce—to
releasably—coupled so as to be substantially nondestructibly removable.
repeatedly—again and again; repetitively.
request—to express a desire for and/or ask for.
remove—to take off of a surface.
retract—to draw back in from an extended position.
scraper—a device comprising an edge, which can be raised or lowered to clean a rake
set—a related plurality.
store—to place, hold, and/or retain.
stuck—caught.
substantially—to a great extent or degree.
support—to bear the weight of, especially from below.
surface—an outer boundary of an object or a material layer.
system—a collection of mechanisms, devices, machines, articles of manufacture, processes, data, and/or instructions, the collection designed to perform one or more specific functions.
tine—a prong on a rake.
tractor—a tractor is an engineering vehicle specifically designed to deliver at a high tractive effort (or torque) at slow speeds, for the purposes of hauling a trailer or machinery used in agriculture or construction.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a rake coupleable to a tractor, said rake comprising a plurality of tines;
a scraper, said scraper coupleable to said tractor, said scraper comprising a metal edge;
an actuator coupleable to said scraper, when said actuator is coupled to said scraper and extended and retracted, said metal edge of said scraper oriented to pass in proximity to a surface of said plurality of tines, thereby removing debris stuck in said tines.

2. The system of claim 1, further comprising:
a hitch constructed to couple said tractor to said rake, wherein;
the hitch defines a plurality of hitch apertures; and
via the plurality of hitch apertures, an angle of the rake is adjustable relative to a direction of travel of the tractor.

3. The system of claim 1, wherein:
said scraper comprises an actuator mounting frame, said actuator mounting frame comprising a pair of flanges, said actuator is directly coupleable to said pair of flanges.

4. The system of claim 1, wherein:
said scraper comprises an actuator mounting frame, said actuator mounting frame comprising a pair of legs and a cross member, said cross member comprising a pair of flanges, said actuator is directly coupleable to said pair of flanges.

5. The system of claim 1, wherein:
said scraper comprises an actuator mounting frame, said actuator mounting frame comprising a pair of legs and a cross member, said cross member is coupled to a pair of flanges, said actuator is directly coupleable to said pair of flanges, wherein a gusset reinforces said pair of legs and said cross member.

6. The system of claim 1, wherein:
said scraper is releasably coupleable to said rake.

7. The system of claim 1, wherein:
said metal edge is comprised by angle iron.

8. The system of claim 1, wherein:
said actuator coupleable to said scraper via a frame, said frame comprising a cross member and a pair of coupling legs.
